(19) United States
(12) Patent Application Publication
(10) Pub. No.: US 2026/0168877 A1
(43) Pub. Date: Jun. 18, 2026

(54) CLOSED VOLUME PRESSURE SENSOR WITH INSECT MITIGATION FEATURES

(71) Applicant: Veoneer US Safety Systems, LLC, Southfield, MI (US)

(72) Inventor: Joshua Forwerck, Royal Oak, MI (US)

(21) Appl. No.: 18/979,007

(22) Filed: Dec. 12, 2024

(51) Int. Cl. G01L 23/08; G01L 19/06

(52) U.S. Cl. CPC G01L 23/08; G01L 19/0645

(57) ABSTRACT

A crash sensor for a vehicle includes: a housing defining an internal volume; a pressure sensor element disposed in the internal volume of the housing; and a membrane configured to isolate the internal volume of the housing from ambient air. The membrane is deformable for transmitting a pressure pulse indicative of a crash for detection by the pressure sensor element.

### CROSS REFERENCE TO RELATED APPLICATIONS

None

### FIELD

The present disclosure relates generally to sensors for vehicles, and more particularly to a pressure sensor for detecting a crash.

### BACKGROUND

Pressure based crash sensors are currently placed in vehicle doors to detect collisions early by monitoring the deformation of the door cavity. Deformation of the door creates a rapid pressure change and the pressure sensor monitors the change of pressure divided by the ambient pressure. Pressure sensor assemblies typically have mechanical housing, pressure port cover, internal gasket and pressure sensor with or without a printed circuit board (PCB).

Pressure sensor assemblies for pressure-based crash sensors are typically configured as an open volume, meaning the air pressure has a direct path to the pressure sensor device. The pressure sensor device typically has a device cover with a restricted opening ranging 0.3 to 2.5 mm. Pressure sensor devices may have openings that are even smaller. The device cover is intended to restrict contamination, debris and insects from entering the device. Insects, such as ants in certain regions of the world, can enter the pressure devices and damage the sensors. Some types of ants may enter through gaps as small as 0.2 mm. Restricting openings in the pressure sensor to 0.2 mm or smaller may present manufacturing difficulties and increases risks of frost, dust and other contamination blocking the openings on the sensor.

### SUMMARY

The present disclosure provides a crash sensor for a vehicle. The crash sensor includes: a housing defining an internal volume; a pressure sensor element disposed in the internal volume of the housing; and a membrane configured to isolate the internal volume of the housing from ambient air. The membrane is deformable for transmitting a pressure pulse indicative of a crash for detection by the pressure sensor element.

The present disclosure also provides a pressure sensor assembly. The pressure sensor assembly includes: a housing defining an internal volume; a pressure sensor element disposed in the internal volume of the housing; and a membrane configured to isolate the internal volume of the housing from ambient air, wherein the membrane is deformable for transmitting a pressure pulse indicative of a crash for detection by the pressure sensor element.

The present disclosure also provides a sensor assembly for a vehicle. The sensor assembly includes: a housing defining an internal volume; a sensor element disposed in the internal volume of the housing; a membrane configured to isolate the internal volume of the housing from ambient air, wherein the membrane is deformable for transmitting a pressure pulse for detection by the sensor element; an equalization passage between the internal volume of the housing and the ambient air; and a breathable membrane of waterproof material covering the equalization passage.

These and other aspects of the present disclosure are disclosed in the following detailed description of the embodiments, the appended claims, and the accompanying figures

### BRIEF DESCRIPTION OF THE DRAWINGS

Further details, features and advantages of designs of the invention result from the following description of embodiment examples in reference to the associated drawings.

FIG. 1 shows a side view of a motor vehicle according to aspects of the disclosure;

FIG. 2 shows a cross-section of a door panel of the motor vehicle and with a first pressure sensor assembly disposed therein;

FIG. 3 shows a cross-section of a first pressure sensor assembly for detecting a crash in a vehicle;

FIG. 4 shows a first pressure sensor element used in a pressure sensor for detecting a crash in a vehicle;

FIG. 5 shows a fragmentary cross-section of the first pressure sensor assembly of FIG. 3;

FIG. 6 shows a fragmentary cross-section of a second pressure sensor assembly in accordance with an aspect of the present disclosure;

FIG. 7 shows a perspective view of an internal seal of the second pressure sensor assembly of FIG. 6;

FIG. 8 shows a perspective view of a second pressure sensor element, in accordance with an aspect of the present disclosure;

FIG. 9 shows a fragmentary cross-section of a third pressure sensor assembly in accordance with an aspect of the present disclosure;

FIG. 10 shows a fragmentary cross-section of a fourth pressure sensor assembly in accordance with an aspect of the present disclosure;

FIG. 11 shows a fragmentary perspective view of a fifth pressure sensor assembly in accordance with an aspect of the present disclosure;

FIG. 12 shows a fragmentary cross-section of the fifth pressure sensor assembly of FIG. 11.

### DETAILED DESCRIPTION

Referring to the drawings, the present invention will be described in detail in view of following embodiments.

The present disclosure provides a pressure sensor assembly with design features to prevent ants or other insects from interfering with operation of a pressure sensor element therein.

The present disclosure includes designing the pressure sensor as a closed volume sensor solution by molding an internal gasket with a thin membrane that will deform with large pressure changes. The internal gasket may be made of a silicone-based material, which may minimize the influence of temperature and aging. The membrane would prevent or detract insects from the electronics inside. The membrane can easily be integrated in existing internal gaskets designs today by a simple tool modification or by replacing internal gasket by over-molding the membrane directly to the plastic cover port as part of the pressure sensor assembly. The membrane can also be integrated into the sensor device at the component device level and provided by a supplier of the pressure sensor element. The membrane thickness and durometer can easily be changed to ensure the transfer function of the pressure pulse is not dampened to detect a crash pulse and can be increased for robustness against insects. The membrane creates a closed volume that will change in pressure with temperature and atmospheric pressure. The sensor device already has existing filter than can compensate for the slow ambient pressure changes due to the closed volume.

A second membrane of breathable waterproof material can be added to the closed volume to help sensor compensate variable ambient pressure changes. This second membrane maybe made, for example, of Gore-Tex.

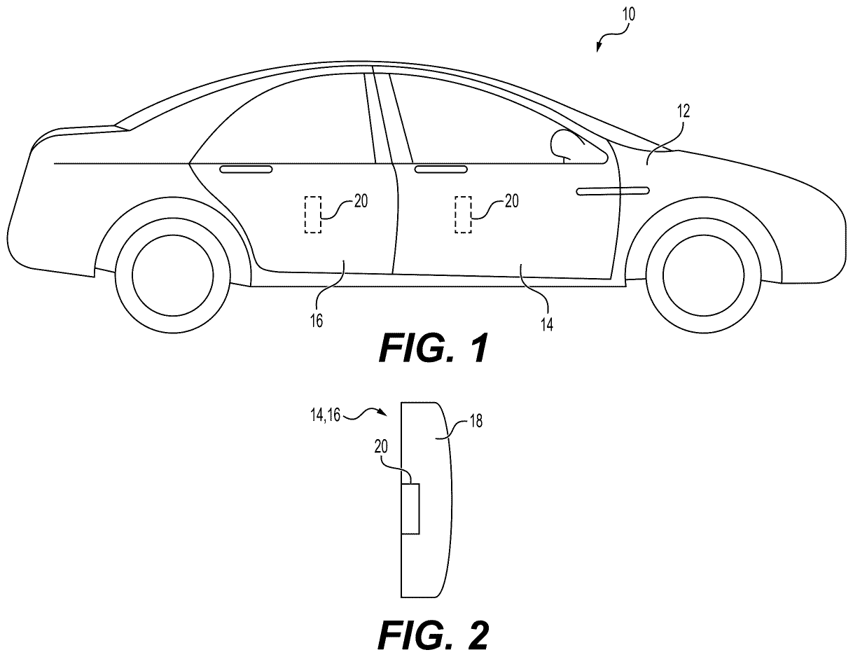

As shown in FIG. 1, a motor vehicle 10, such as a passenger car or truck, includes a body 12 having side doors 14, 16. The side doors 14, 16 include a front door 14 and a rear door 16. FIG. 2 shows a cross-section of one of the side doors 14, 16, defining a door cavity 18, with a first pressure sensor assembly 20 disposed therein. The door cavity 18 may be a generally-closed volume with limited openings, such as a gasket for a window and one or more weep holes for liquid drainage.

The door cavity 18 may be deformed during a crash that impacts the corresponding one of the side doors 14, 16, resulting in a sudden pulse in air pressure, which may be detected by the first pressure sensor assembly 20. Pressure-based crash detection may have several advantages over other types of crash detection, such as acceleration-based detection. For example, pressure-based crash detection can provide a faster signal than an acceleration-based detector, which can improve performance of side-protection devices, such as side curtain air bags.

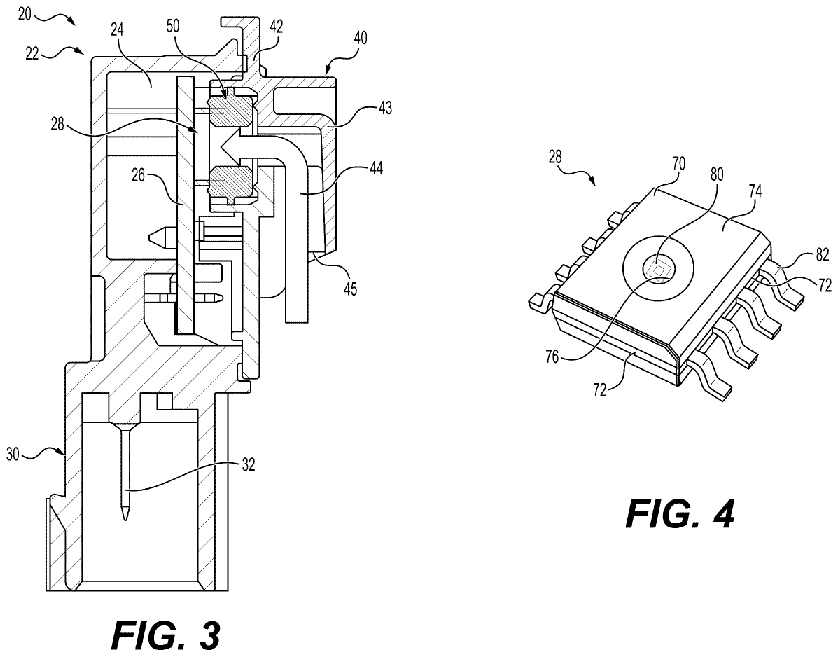

FIG. 3 shows a cross-section of a first pressure sensor assembly 20 for detecting a crash in a vehicle. The first pressure sensor assembly 20 may represent a conventional design and includes a housing 22 that defines an internal volume 24 containing a printed circuit board (PCB) 26 and a first pressure sensor element 28. The first pressure sensor element 28 may be, for example, a surface-mounted micro-electromechanical systems (MEMS) device that is configured to measure air pressure. The housing 22 defines an electrical receptacle 30 having pins 32 for receiving a corresponding plug for electrical connection to the first pressure sensor element 28 and/or other components on the PCB 26.

The first pressure sensor assembly 20 also includes a cover 40 that defines a plate 42 overlying the housing 22 to at least partially enclose the internal volume 24. The cover 40 may be attached to the housing 22 using a snap-fit and with a gasket. Alternatively, the cover 40 may be permanently sealed to the housing 22. For example, the cover 40 may be attached to the housing 22 by laser welding, ultrasonic welding, using an adhesive, and/or otherwise adhered. The cover 40 includes a protruding structure 43 on the plate 42 opposite from the internal volume 24. The protruding structure 43 defines a channel 44 having an opening 45 opposite of the first pressure sensor element 28. The channel 44 may, therefore, and conduct the ambient air to the first pressure sensor element 28. In some embodiments, and as shown in FIG. 3, the channel 44 defines a 90-degree bend. In some embodiments, and as also shown in FIG. 3, the opening 45 of the channel 44 is disposed below the first pressure sensor element 28. This arrangement may function similar to an inverted cup, trapping air and preventing water intrusion in case the first pressure assembly is submerged. A first internal seal 50 is disposed between the cover 40 and the first pressure sensor element 28. The first internal seal 50 may be made of a resilient material, such as silicone, and provides a direct path between the channel 44 and the first pressure sensor element 28. Alternatively, the first internal seal 50 may be made of another material, such as a rubber-based material or a thermoplastic elastomer (TPE). In some embodiments, the first internal seal 50 may be directly molded into the cover 40 using a 2-shot process.

FIG. 4 shows a first pressure sensor element 28 of the first pressure sensor assembly 20. The first pressure sensor element 28 includes a body 70 having four side walls 72 and a top 74 that defines a port hole 76. The first pressure sensor element 28 also includes a sensor device 80 mounted within the body 70 and which is connected to external circuitry via a plurality of conductors 82 that protrude through two or more of the four side walls 72. The port hole 77 may have a diameter of about 2.5 mm. In an alternative design (not shown), the top 74 may instead have a plurality of smaller holes, such as four holes each having a diameter of 0.2 mm. These smaller holes may prevent debris and insects from entering the body 70 of the first pressure sensor element 28. However, such restricted openings can be difficult to manufacture and can increase risks of frost, dust and other contamination blocking the holes on the sensor.

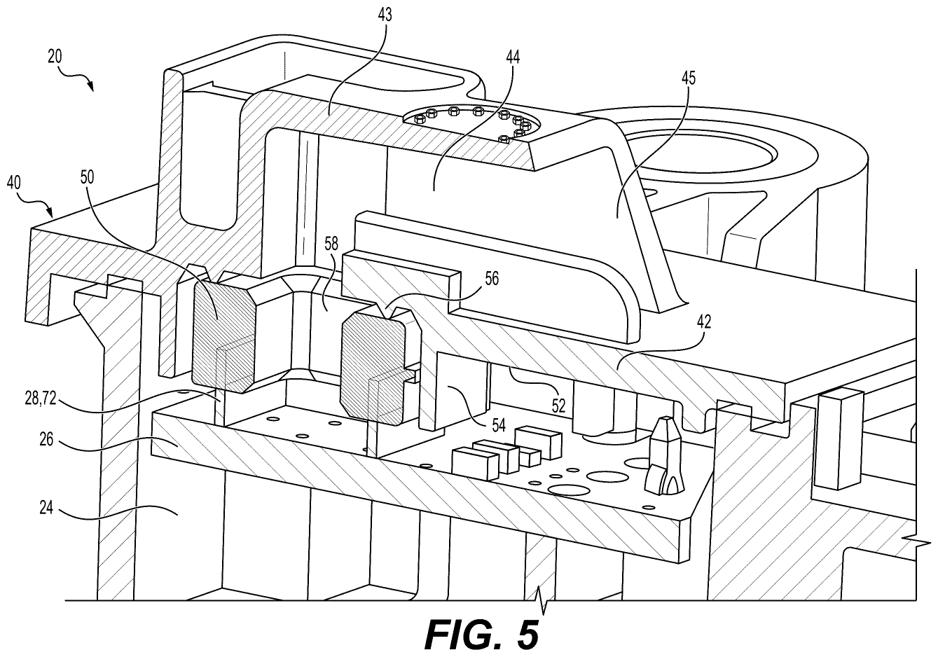

FIG. 5 shows a fragmentary cross-section of the first pressure sensor assembly 20. As shown, the plate 42 includes an interior surface 52 facing the internal volume 24. A square wall 54 protrudes from the interior surface 52 toward the PCB 26 and surrounds the first internal seal 50 for locating the first internal seal 50 in a direct fluid path with the channel 44. The interior surface 52 of the plate 42 also defines a triangular protrusion 56 that contacts the first internal seal 50 to cause the first internal seal 50 to be deformed between the triangular protrusion 56 and the first pressure sensor element 28 and to form an airtight seal. As also shown, the first internal seal 50 has a generally toroidal shape with a bore 58 to pass air ambient air to the first pressure sensor element 28 via the channel 44. The generally toroidal shape the first internal seal 50 may have a rounded-rectangle cross-section, as shown in the FIGs. However, the first internal seal 50 may have a different cross-sectional shape, such as a rectangular shape, a round shape, an oval shape, etc. The bore 58 may have a generally rectangular cross-sectional shape, as shown. However, the bore 58 may have another shape, such as a round or oval cross-section.

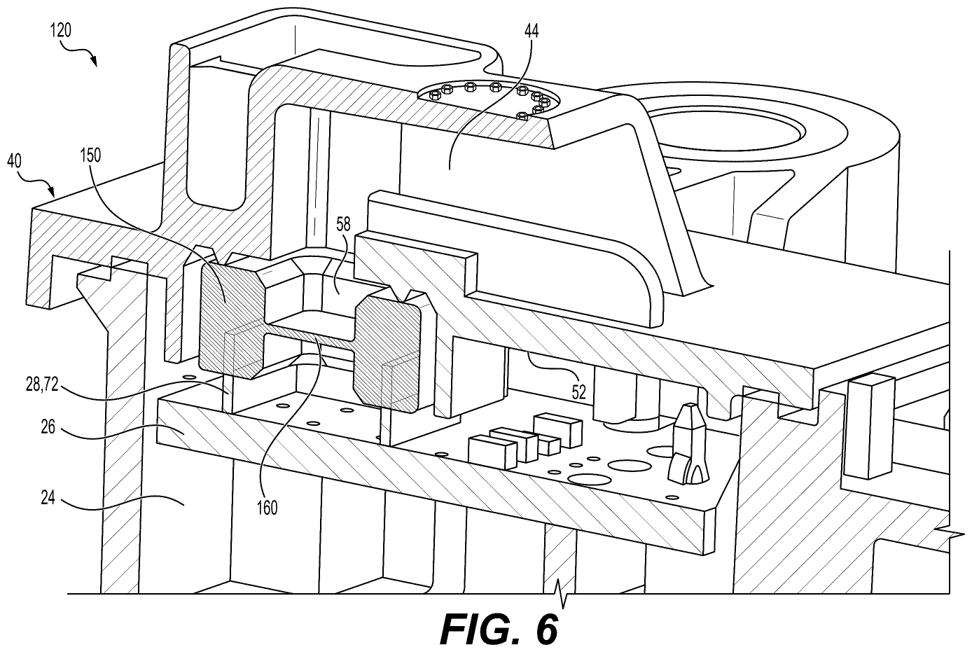

FIG. 6 shows a fragmentary cross-section of a second pressure sensor assembly 120 in accordance with an aspect of the present disclosure. The second pressure sensor assembly 120 may be similar or identical to the first pressure sensor assembly 20 except for differences described herein. The second pressure sensor assembly 120 includes a second internal seal 150 in place of the first internal seal 50. The second internal seal 150 includes a first membrane 160 across a center of the bore 58 and preventing fluid communication through the second internal seal 150. Therefore, the second internal seal 150 functions to block fluid communication between the ambient space and the internal volume 24 of the housing 22 that. The first membrane 160 is flexible and deforms in response to a pressure pulse, and therefore does not impede the first pressure sensor element 28 from detecting a pressure pulse that is indicative of a crash. In some embodiments, the first membrane 160 may be integrally formed with the second internal seal 150, for example, as a single molded piece. However, the first membrane 160 may be formed separately and/or from a different material as other parts of the second internal seal 150.

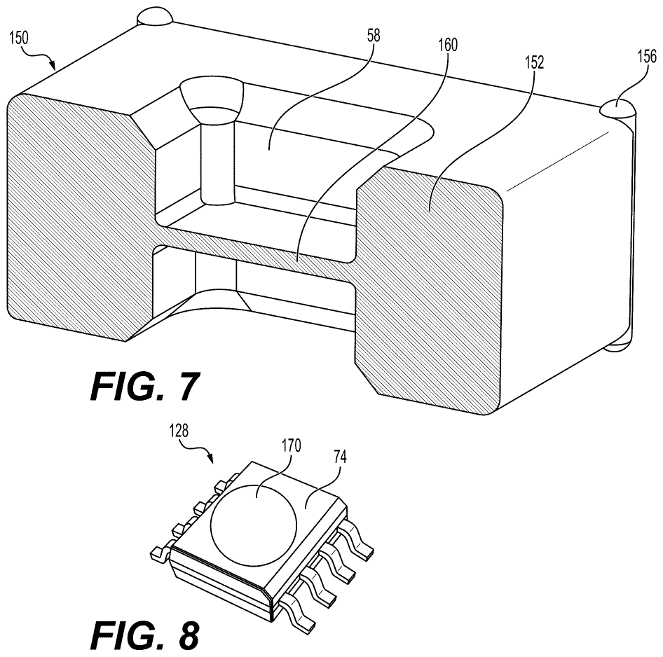

FIG. 7 shows a perspective view of the second internal seal 150. As shown, the second internal seal 150 includes a tubular portion 152 having generally cuboid toroidal shape defining a bore 58 and with the first membrane 160 disposed across a center of the bore 58. The second internal seal 150 also includes domed protrusions 156 at each outside corner. The domed protrusions 156 may engage corresponding structures on the interior surface 52 of the plate 42 and/or on the top 74 of the first pressure sensor element 28.

FIG. 8 shows a perspective view of a second pressure sensor element 128, in accordance with an aspect of the present disclosure. The second pressure sensor element 128 may be similar or identical to the first pressure sensor element 28 except for differences described herein. The second pressure sensor element 128 includes a second membrane 170 of resilient material, such as a film of silicone, attached directly to the top 74 of the first pressure sensor element 28 and overlying the port hole(s) (not shown on FIG. 8). The second pressure sensor element 128 may be used in place of the first pressure sensor element 28 for preventing insects or debris from contacting the sensor device 80. The second membrane 170 may be made of a flexible material that deforms in response to a pressure pulse, and therefore does not impede the second pressure sensor element 128 from detecting a pressure pulse that is indicative of a crash.

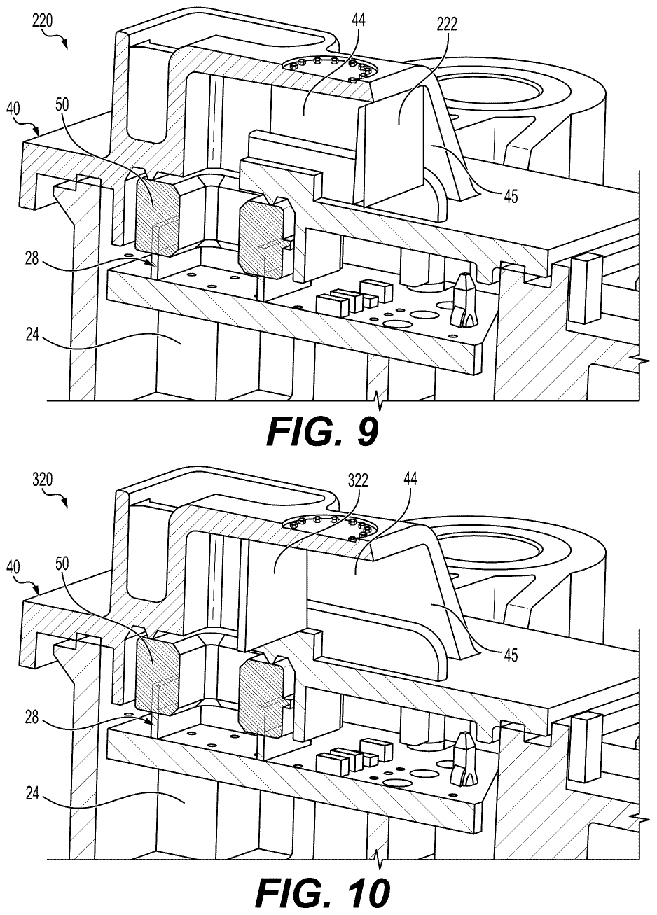

FIG. 9 shows a fragmentary cross-section of a third pressure sensor assembly 220 in accordance with an aspect of the present disclosure. The third pressure sensor assembly 220 may be similar or identical to the first pressure sensor assembly 20 except for differences described herein. The second pressure sensor assembly 120 includes a third membrane 222 within the channel 44 and adjacent to the opening 45. The third membrane 222 may span across the channel 44 for blocking direct air communication between the ambient air and the first pressure sensor element 28. The third membrane 222 may be made of a flexible material that deforms in response to a pressure pulse, and therefore does not impede the first pressure sensor element 28 from detecting a pressure pulse that is indicative of a crash.

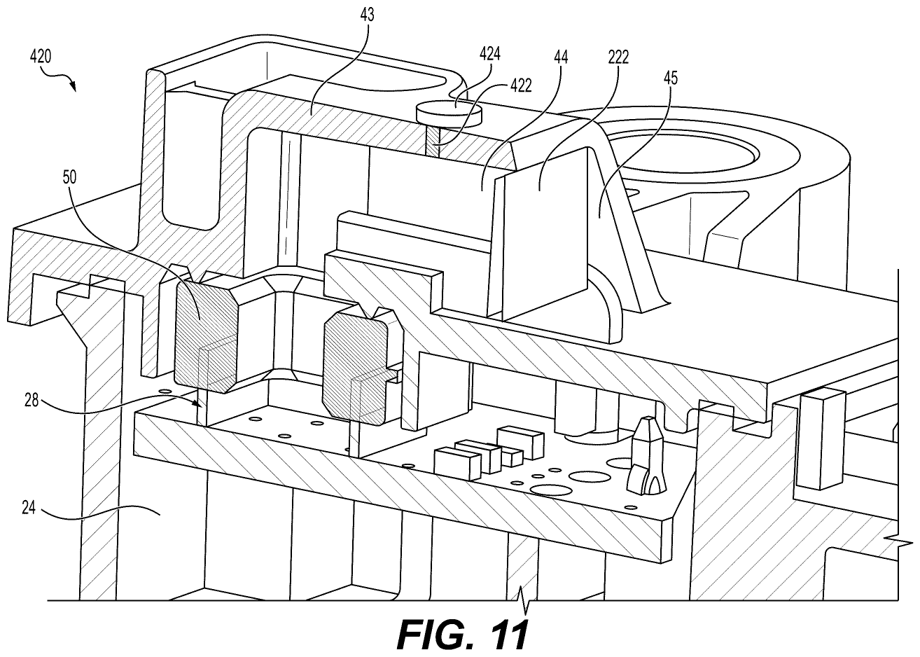

FIG. 10 shows a fragmentary cross-section of a fourth pressure sensor assembly 320 in accordance with an aspect of the present disclosure. The fourth pressure sensor assembly 320 may be similar or identical to the first pressure sensor assembly 20 except for differences described herein. The fourth pressure sensor assembly 320 includes a fourth membrane 322 within the channel 44 and spaced apart from the opening 45. The fourth membrane 322 may span across the channel 44 for blocking direct air communication between the ambient air and the first pressure sensor element 28. The fourth membrane 322 may be made of a flexible material that deforms in response to a pressure pulse, and therefore does not impede the first pressure sensor element 28 from detecting a pressure pulse that is indicative of a crash.

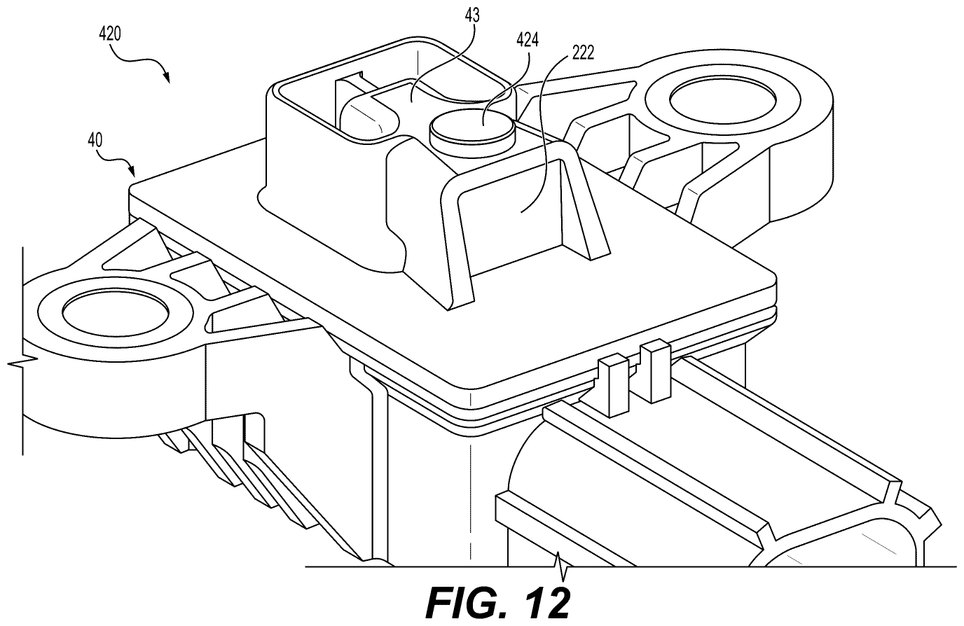

FIGS. 11-12 each show a fifth pressure sensor assembly 420 in accordance with an aspect of the present disclosure. The fifth pressure sensor assembly 420 may be similar or identical to the third pressure sensor assembly 220 except for differences described herein. The protruding structure 43 of the cover 40 defines an equalization passage 422 between the internal volume 24 of the housing 22 and the ambient air. The equalization passage 422 may allow the internal volume 24 of the housing 22 to slowly equalize pressure with the ambient air, for example in response to changing ambient air pressure with changing temperature or changing atmospheric pressure or as the vehicle 10 is driven up or down a change in elevation. The equalization passage 422 may be restrictive to airflow so as not to impede detection by the first pressure sensor element 28 of a sudden change in ambient air pressure that is indicative of a crash. A breathable membrane 424 of waterproof material, such as Gore-Tex, covers the equalization passage 422. The breathable membrane 424 may air to pass through relatively unimpeded, while preventing water, and/or other contaminants from passing through. The equalization passage 422 is shown through the protruding structure 43 and into the channel 44. However, the equalization passage 422 and the breathable membrane 424 could be located elsewhere on the cover 40 and/or elsewhere on the housing 22.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A crash sensor for a vehicle, comprising:
a housing defining an internal volume;
a pressure sensor element disposed in the internal volume of the housing; and
a membrane configured to isolate the internal volume of the housing from ambient air, wherein the membrane is deformable for transmitting a pressure pulse indicative of a crash for detection by the pressure sensor element.

2. The crash sensor for a vehicle of claim 1, further including:
a cover overlying the housing to at least partially enclose the internal volume, the cover defining a channel having an opening opposite from the pressure sensor element; and
an internal seal disposed between the cover and the pressure sensor element.

3. The crash sensor for a vehicle of claim 2, wherein the internal seal has a generally toroidal shape defining a bore, and wherein the membrane is disposed within the bore of the internal seal.

4. The crash sensor for a vehicle of claim 2, wherein the membrane is integrally formed with the internal seal.

5. The crash sensor for a vehicle of claim 2, wherein the internal seal is made of at least one of: silicone, a rubber-based material, or a thermoplastic elastomer (TPE).

6. The crash sensor for a vehicle of claim 1, wherein the pressure sensor element includes a body having a top that defines a port hole, and wherein the membrane is attached directly to the top of the pressure sensor element and overlying the port hole.

7. The crash sensor for a vehicle of claim 1, further including a cover overlying the housing to at least partially enclose the internal volume, the cover defining a channel having an opening opposite from the pressure sensor element, and
wherein the membrane is disposed in the channel and adjacent to the opening.

8. The crash sensor for a vehicle of claim 1, further including a cover overlying the housing to at least partially enclose the internal volume, the cover defining a channel having an opening opposite from the pressure sensor element, and
wherein the membrane is disposed in the channel and spaced apart from the opening.

9. The crash sensor for a vehicle of claim 1, further including:
an equalization passage between the internal volume of the housing and the ambient air; and
a breathable membrane of waterproof material covering the equalization passage.

10. A pressure sensor assembly, comprising:
a housing defining an internal volume;
a pressure sensor element disposed in the internal volume of the housing; and
a membrane configured to isolate the internal volume of the housing from ambient air, wherein the membrane is deformable for transmitting a pressure pulse indicative of a crash for detection by the pressure sensor element.

11. The pressure sensor assembly of claim 10, further including:
a cover overlying the housing to at least partially enclose the internal volume, the cover defining a channel having an opening opposite from the pressure sensor element; and
an internal seal disposed between the cover and the pressure sensor element.

12. The pressure sensor assembly of claim 11, wherein the internal seal has a generally toroidal shape defining a bore, and wherein the membrane is disposed within the bore of the internal seal.

13. The pressure sensor assembly of claim 11, wherein the membrane is integrally formed with the internal seal.

14. The pressure sensor assembly of claim 11, wherein the internal seal is made of at least one of: silicone, a rubber-based material, or a thermoplastic elastomer (TPE).

15. The pressure sensor assembly of claim 10, wherein the pressure sensor element includes a body having a top that defines a port hole, and wherein the membrane is attached directly to the top of the pressure sensor element and overlying the port hole.

16. The pressure sensor assembly of claim 10, further including a cover overlying the housing to at least partially enclose the internal volume, the cover defining a channel having an opening opposite from the pressure sensor element, and
wherein the membrane is disposed in the channel and adjacent to the opening.

17. The pressure sensor assembly of claim 10, further including a cover overlying the housing to at least partially enclose the internal volume, the cover defining a channel having an opening opposite from the pressure sensor element, and
wherein the membrane is disposed in the channel and spaced apart from the opening.

18. The pressure sensor assembly of claim 10, further including:
an equalization passage between the internal volume of the housing and the ambient air; and
a breathable membrane of waterproof material covering the equalization passage.

19. A sensor assembly for a vehicle, comprising:
a housing defining an internal volume;
a sensor element disposed in the internal volume of the housing;
a membrane configured to isolate the internal volume of the housing from ambient air, wherein the membrane is deformable for transmitting a pressure pulse for detection by the sensor element;
an equalization passage between the internal volume of the housing and the ambient air; and
a breathable membrane of waterproof material covering the equalization passage.

20. The sensor assembly of claim 19, further including:
a cover overlying the housing to at least partially enclose the internal volume, the cover defining a channel having an opening opposite from the sensor element; and
an internal seal disposed between the cover and the sensor element, wherein the internal seal has a generally toroidal shape defining a bore, and wherein the membrane is disposed within the bore of the internal seal.
